(19) United States
(12) Patent Application Publication
(10) Pub. No.: US 2025/0258714 A1
(43) Pub. Date: Aug. 14, 2025

(54) ROBUST RESOURCE MANAGEMENT SYSTEMS AND DYNAMIC METHODS FOR OPERATING THE SAME

(71) Applicant: Weyerhaeuser NR Company, Seattle, WA (US)

(72) Inventors: Chris Musselman, Covington, WA (US); Craig Lloyd Forbes, Hot Springs, AR (US); Tianyi Wu, Seattle, WA (US)

(21) Appl. No.: 19/054,592

(22) Filed: Feb. 14, 2025

Related U.S. Application Data
(60) Provisional application No. 63/553,348, filed on Feb. 14, 2024.

(51) Int. Cl. G06F 9/50

(52) U.S. Cl. CPC G06F 9/5033

(57) ABSTRACT

Systems and methods are disclosed comprising instructions to receive real-time operation logs for at least one allocable resource unit corresponding to a target unit value, determine a set of key performance indicators (KPIs) for the at least one allocable resource unit using a set of operational attributes of the real-time operation logs, generate a forecasting time-series dataset using the real-time operation logs in response to at least one KPI failing to satisfy a stability threshold, generate a set of adjustment values for the forecasting time-series dataset using the set of profiling attributes for a receiving end user, determine a modified target unit value for the at least one allocable resource unit based on the forecasting time-series dataset and the set of adjustment values, and display a notification alert indicating deviation of the at least one KPI and recommendation for adjusting the target unit value.

### CROSS-REFERENCE TO RELATED APPLICATIONS

This application claims the benefit of priority to U.S. Provisional Patent Application No. 63/553,348, filed on Feb. 14, 2024, entitled PREDICTIVE ASSET MANAGEMENT SYSTEMS AND METHODS, which is hereby incorporates by reference in its entirety.

### BACKGROUND

In cloud computing, efficient resource management is a primary concern. As the demand for cloud services continues to grow, efficient resource management becomes crucial to ensure optimal utilization of resources, cost-effectiveness, and high-performance delivery of services. Traditional resource management approaches often rely on manual configurations or static provisioning, resulting in inefficient resource utilization which increases costs, and poor performance due to underutilization.

In traditional inventory management, predicting when stock levels will become low or when sales will decrease is challenging, often resulting in excess inventory. This issue can significantly impact a company's profitability. For example, excess inventory occupies valuable resources such as warehouse space, working capital, and personnel time, leading to additional costs for storage, handling, and maintenance. Furthermore, excess inventory can become outdated, necessitating disposal and resulting in financial losses. Additionally, excess inventory can occupy warehouse space that could be used for new products, leading to missed sales opportunities and revenue.

In some examples, Warehouse Management Systems (WMS) are used to manage and monitor inventory. However, these systems have limited visibility and inaccurate information due to incorrectly entered information. Overall, WMS systems also lack the ability to forecast future business needs for inventory. Beyond this issue, addressing the challenge of high sales during a low market can be difficult, leading to pricing pressure for the company. For instance, the company may feel compelled to reduce prices to maintain its market position, resulting in reduced profit margins and lower overall profitability.

Current systems, such as Enterprise Resource Planning (ERP) systems, provide a centralized platform for managing inventory levels, tracking sales performance, and generating logs. However, ERPs are limited in their ability to provide detailed customer information and are not designed for comprehensive sales monitoring and analysis. Moreover, ERP systems lack the capability to forecast future sales.

Other systems, such as Customer Relationship Management (CRM) systems, consist of software applications used to manage customer interactions and relationships. However, CRM systems do not offer a complete view of a business's sales performance. For example, CRMs do not provide detailed information on product performance and lack real-time data capabilities. Consequently, it is challenging for companies to react swiftly to market changes.

### BRIEF DESCRIPTION OF THE DRAWINGS

Detailed descriptions of implementations of the present invention will be described and explained through the use of the accompanying drawings.

FIG. 1 is a system diagram illustrating an example of a computing environment in which the disclosed system operates in some implementations.

FIG. 2 is a block diagram that illustrates a resource management system that can implement aspects of the present technology.

FIGS. 3A-3B show an example graphical user interface that demonstrates aspects of a resource management interface in accordance with some implementations of the present technology.

FIG. 4 is a flow diagram that illustrates an example process for managing distribution operations for resource units in accordance with some implementations of the disclosed technology.

FIG. 5 illustrates a layered architecture of an artificial intelligence system that can implement the machine learning models of the resource management system, in accordance with some implementations of the present technology.

FIG. 6 is a block diagram of an example transformer that can implement aspects of the present technology.

FIG. 7 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Organizations rely on Warehouse Management Systems (WMS), Customer Relationship Management (CRM), and Enterprise Resource Planning (ERP) systems to manage inventory and sales operations. However, these systems do not provide a comprehensive view of the business operations of the company. Additionally, existing systems have limited capabilities to predict future market trends because they do not account for the variety and disparate data and/or market conditions that impact the demand and price of products. By largely ignoring synergetic analysis of different data modalities (e.g., pricing records, inventory manifests, sale quotas, and/or the like), conventional management systems often overlook correlated information that can signal subtle and/or significant market trends for a select asset. Existing systems are further limited in their ability to generate, suggest, and/or predict changes in future product attributes (e.g., price, inventory, etc.) in response to the changing market in real time. As a result, organizations struggle with maintaining an optimal balance between sales and inventory levels, which leads to excess/not enough inventory and missed sales opportunities.

The address these and other problems of conventional systems, the current invention introduces a robust resource management system that generates key performance indicator (KPI) data using data obtained from disparate sources, such as asset attribute records (e.g. pricing records, discount data, surcharge data), transportation data (e.g., freight, cost, rebate, tax, and/or the like), and transaction data (e.g., sale transaction data) to generate near real-time output results, such as price quotes, quantity quotes, and the like. As a result, the system can proactively detect anomalous patterns and/or fluctuations in asset attributes (e.g., changes in sales price, market conditions, sales volume, inventory, and/or the like). Examples of KPIs include, but are not limited to, actual price to target, actual price to market, transactional sale variability, and inventory levels. The resource management system further provides a feature-rich dashboard to display the various outputs from the application of the trained machine learning models, various trigger-related information, and the like.

Additionally, the current invention introduces a predictive resource management system that generates real-time remediation strategies in response to real-time changes to detected KPIs. For example, the system can use data from the disparate asset records to generate an approximate time-series data samples predicting future asset attributes (e.g., sale asset price, market asset price, and/or the like) over a time interval. Accordingly, the system can generate recommended adjustments for one or more controlled asset attributes (e.g., target asset price) to subscribed users (e.g., third-party vendors, manufacturers, and/or the like). In some implementations, the system can also intelligently apply granular adjustments to predicted asset attributes using contextual information of asset buyers and consumers (e.g., purchasing preferences, user demographics, and/or the like).

For illustrative purposes, examples are described herein in the context of asset and resource management systems for market pricing. However, a person skilled in the art will appreciate that the disclosed system can be applied in other contexts. As an illustrative example, the disclosed management system can be used in the healthcare field to proactively analyze and accurately predict future chemical balances associated with complex drug administration. Accordingly, the system can be used to determine real-time adjustments to pharmaceutical dosages to maintain stable body chemistry.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Example Computing Environment

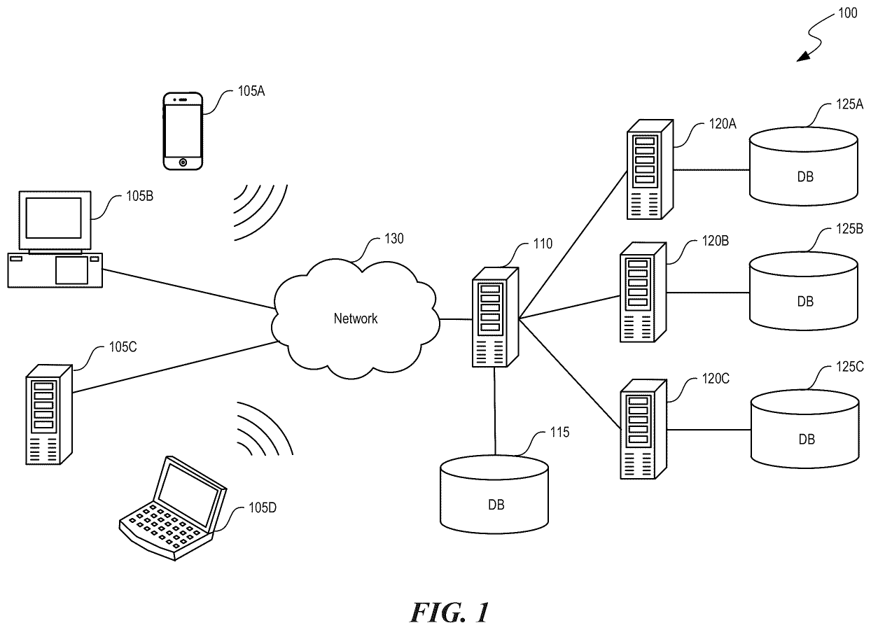

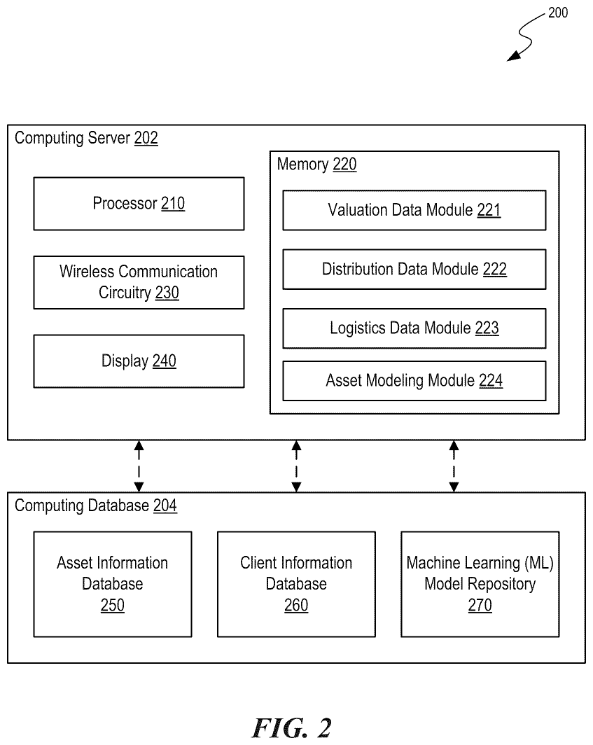

FIG. 1 is a system diagram illustrating an example of a computing environment in which the disclosed system operates in some implementations. In some implementations, environment 100 includes one or more end user computing devices 105A-D, examples of which can host the resource management system 200 of FIG. 2. End user computing devices 105 operate in a networked environment using logical connections through network 130 to one or more remote computers, such as a server computing device.

In some implementations, server 110 is an edge server which receives end user requests and coordinates fulfillment of those requests through other servers, such as servers 120A-C. In some implementations, server computing devices 110 and 120 comprise computing systems, such as the resource management system 200 of FIG. 2. Though each server computing device 110 and 120 is displayed logically as a single server, server computing devices can each be a distributed as a computing environment encompassing multiple computing devices located at the same or at geographically disparate physical locations. In some implementations, each server 120 corresponds to a group of servers.

End user computing devices 105 and server computing devices 110 and 120 can each act as a server or end user to other server or end user devices. In some implementations, servers (110, 120A-C) connect to a corresponding database (115, 125A-C). As discussed above, each server 120 can correspond to a group of servers, and each of these servers can share a database or can have its own database. Databases 115 and 125 warehouse (e.g., store) information such as claims data, email data, call transcripts, call logs, policy data and so on. Though databases 115 and 125 are displayed logically as single units, databases 115 and 125 can each be a distributed computing environment encompassing multiple computing devices, can be located within their corresponding server, or can be located at the same or at geographically disparate physical locations.

Network 130 can be a local area network (LAN) or a wide area network (WAN), but can also be other wired or wireless networks. In some implementations, network 130 is the Internet or some other public or private network. End user computing devices 105 are connected to network 130 through a network interface, such as by wired or wireless communication. While the connections between server 110 and servers 120 are shown as separate connections, these connections can be any kind of local, wide area, wired, or wireless network, including network 130 or a separate public or private network.

### Resource Management System

FIG. 2 is a block diagram that illustrates a resource management system (referred to as “resource management system 200” or “system 200”) that can implement aspects of the present technology. The components shown in FIG. 2 are merely illustrative, and well-known components are omitted for brevity. As shown, the computing server 202 includes a processor 210, a memory 220, a wireless communication circuitry 230 to establish wireless communication channels (e.g., telecommunications, internet) with other computing devices and/or services (e.g., servers, databases, cloud infrastructure), and a display 240. The processor 210 can have generic characteristics similar to general-purpose processors, or the processor 210 can be an application-specific integrated circuit (ASIC) that provides arithmetic and control functions to the computing server 202. While not shown, the processor 210 can include a dedicated cache memory. The processor 210 can be coupled to all components of the computing server 202, either directly or indirectly, for data communication. Further, the processor 210 of the computing server 202 can be communicatively coupled to a computing database 204 that is hosted alongside the computer server 202 on the network 130 described in reference to FIG. 1. As shown, the computing database 204 can include an asset information database 250, end user information database 260, and a machine learning (ML) model repository 270.

The memory 220 can comprise any suitable type of storage device including, for example, a static random-access memory (SRAM), dynamic random-access memory (DRAM), electrically erasable programmable read-only memory (EEPROM), flash memory, latches, and/or registers. In addition to storing instructions that can be executed by the processor 210, the memory 220 can also store data generated by the processor 210 (e.g., when executing the modules of an optimization platform). In additional or alternative implementations, the processor 210 can store temporary information onto the memory 420 and store long-term data onto the computing database 204. The memory 220 is merely an abstract representation of a storage environment. Hence, in some implementations, the memory 220 comprises one or more actual memory chips or modules.

As shown in FIG. 2, modules of the memory 220 can include a valuation data module 221, a distribution data module 222, a logistics data module 223, and an asset modeling module 224. Other implementations of the computing server 202 include additional, fewer, or different modules, or distribute functionality differently between the modules. As used herein, the term “module” refers broadly to software components, firmware components, and/or hardware components. Accordingly, the modules 221, 222, 223, and 224 could each comprise software, firmware, and/or hardware components implemented in, or accessible to, the computing server 202.

### Operations Data Collection

The valuation data module 221 can be configured to obtain operation logs pertaining to valuation of allocable resource units (alternatively referred to as “resource units” or individually as “resource unit”) managed by an external user (e.g., a third-party vendor, a manufacturer, and/or the like). For example, the valuation data module 221 can receive (e.g., via a user interface) one or more valuation records (e.g., pricing records) for an allocable resource unit (e.g., an asset, a stock unit, an exchangeable good, and/or the like) owned and/or managed by the external user. The valuation records for a resource unit can include a standard unit value (e.g., a base price) of the resource unit, an applicable discount value for the resource unit, and additional payment values (e.g., surcharges). The valuation data module 221 can receive valuation records as transmitted statistical summaries, or similar modular data structures (e.g., JSON, YAML, XML, HTTP/S payloads, and/or the like). The valuation data module 221 can store received valuation records in the asset information database 250.

The distribution data module 222 can be configured to obtain operation logs and/or information pertaining to distribution of the allocable resource units (e.g., sales and/or transactions of assets) managed by an external user via the resource management system 200. For example, the distribution module 222 can deploy automated processes (e.g., background listening programs) that actively monitor communications channels (e.g., internet protocol, telecommunications services, and/or the like) for up-to-date distribution records (e.g., sales and/or transaction history logs, purchase orders, and/or the like) for an allocable resource unit. Examples of distribution records for a resource unit can include sales and/or transaction quotes exchanged (e.g., via telephone communications) between vendors and buyers in real-time. The distribution records for a resource unit can include a distribution unit value (e.g., a sale price), a unit value of equivalent, or alternative resource units (e.g., prices of competing products), and additional profiling attributes (e.g., demographic information, purchasing history, and/or the like) that characterize individual receiving end users (e.g., buyers) of the allocable resource unit. In some implementations, the distribution data module 22 can receive (e.g., via a user interface) distribution records as formal documents (e.g., quote records, transaction log, and/or the like) submitted by the external user. The distribution data module 222 can store received distribution records in the asset information database 250. In additional or alternative implementations, the distribution data module 222 can store end user related data (e.g., the profiling attributes) in the separate end user information database 260.

In some implementations, the distribution data module 222 can deploy a plurality of probes for monitoring increased volumes of operations data. For example, the distribution data module 222 can deploy multiple background listening programs in parallel to capture additional operational records for the resource unit in real-time. In some implementations, the distribution data module 222 can be configured to automatically generate formatted distribution records based on information collected from an ongoing service call between a vendor and a buyer (e.g., translating audio information into formal sales quote documentation). For example, the distribution data module 222 can apply a statistical inferencing algorithm (e.g., a machine learning model) to transcribe audio signal data from a sale conversion into alphanumeric text. Accordingly, the distribution data module 222 can extract and/or repackage select information from the transcribed text (e.g., agreed upon sale price, transaction volume, negotiation values, and/or the like) into a proper formatted quote document.

The logistics data module 223 can be configured to obtain operation logs and/or information pertaining to logistical parameters of the allocable resource units (e.g., inventory stock, asset supply/production rate, and/or the like) managed by an external user via the resource management system 200. For example, the logistics data module 223 can receive (e.g., via a user interface) one or more logistics records (e.g., inventory manifests, production supply information, and/or the like) for an allocable resource unit owned and/or managed by the external user. In some implementations, the logistics records can include additional operational variables (e.g., miscellaneous business costs) associated with distribution of the allocable resource units. For example, the logistics records can include a transportation fee, a production cost, a compulsory fee or obligation (e.g., taxation), a surplus value (e.g., rebates, profit, and/or the like). The logistics data module 223 can store received logistics records in the asset information database 250.

### Resource Valuation Modeling

The asset modeling module 224 can be configured to perform real-time processes for evaluating operations and/or distributive actions for allocable resource units, such as assessments of key performance indicators (KPIs), generation of forecasting data samples for operational attributes (e.g., predicted prices and/or fluctuation patterns), precautionary recommendations for adjusting operation management practices (e.g., modifying target sales price of assets, increasing stock production, balancing existing inventory units, and/or the like), and/or streamlined visualization of real-time analytics (e.g., an automatically updating user interface).

The asset modeling module 224 can perform these processes using information extracted from operations records (e.g., valuation records, distribution records, logistics records, and/or the like) stored in the asset information database 250. In additional or alternative implementations, the asset modeling module 224 can perform one or more of these processes using end user specific information stored in the end user information database 260. As a result, the asset modeling module 224 can be configured to adjust one or more results generated from these processes based on detailed consumer information, ensuring that operation and/or distribution practices (e.g., pricing strategies) are tailored to the specific needs and behaviors of different customer groups. In some implementations, the asset modeling module 224 can use one or more statistical inferencing models and/or machine learning models (e.g., a large language model, a clustering model, an optimization model, and/or the like) stored in the ML repository 270.

### Evaluation of Key Performance Indicators (KPIs)

The asset modeling module 224 can be configured to evaluate one or more KPIs for an allocable resource unit based on the collected and/or stored operation logs (e.g., valuation records, distribution records, logistics records, and/or the like) in the asset information database 250. For example, the asset modeling module 224 can extract one or more operational attributes (e.g., target unit price, realized unit price, and/or the like) from the real-time operations logs stored in the database 250. The asset modeling module 224 can apply one or more specialized algorithms (e.g., rule based logic systems) to generate one or more KPI metrics from the input operational attributes. In additional or alternative implementations, the asset modeling module 224 can use a machine learning model to approximate the values of the KPI metrics in lieu of using specialized algorithms.

By using the specialized algorithms described herein to evaluate select KPIs for distribution activity of an allocable resource unit, the asset modeling module 224 enables external users (e.g., a third-party vendor, an asset manager, and/or the like) to consistently and precisely capture market trends early. Accordingly, the resource management system 200 applies holistic analytical methods (e.g., via combination of valuation, distribution, logistics, and/or end user information) that ensure end users can enact informed decisions while adapting swiftly to dynamic market conditions.

The KPI metrics can include a shift in actual sales price versus the target sales price (AvT), a shift in sales volume variability, a shift in target price movement, and/or a shift in inventory levels. Accordingly, the KPIs collectively provide a robust framework for real-time market analysis for managed resource units. An ordinary person skilled in the art will appreciate that the KPIs described herein are not limiting and that the resource management system 200 is capable of evaluating similar and/or related KPI metrics that may not be explicitly discussed herein.

A shift in the actual sales price versus the target sales price refers to a deviation metric between the actual observed price for a product compared to the target price over a time interval. The target price refers to a internal price set by a vendor (e.g., a manufacturer's suggested retail price (MSRP)) for selling assets and/or stock units. The actual price, or realized price, refers to the sales price at which the vendor sold the asset. For example, the vendor can set a target price for a product at ten dollars while the asset is sold for fifteen dollars, resulting in an AvT of three over two. Over a time interval, the product can be sold for more than fifteen dollars which indicates a shift in actual price versus target price.

The asset modeling module 224 can apply a specialized algorithm (e.g., a rule based logic) to the real-time operations logs (e.g., stored in the asset information database 250) and generate the shift in actual sales price vs the target sales price metric from extracted operational attributes. For example, the asset modeling module 224 can supply the specialized algorithm with relevant operational attributes (e.g., the actual sales price and the target sales price) to identify any deviations. By analyzing these trends, the asset modeling module 224 proactively identifies when realized sales prices significantly deviate from the target sales price set by the vendor, indicating an abnormal market trend. As a result, the asset modeling module 224 can perform additional processes described herein to identify recommended adjustments to the target sales price to better align with market realities.

A shift in sales volume variability pertains to the fluctuation in sales volume over a specified time interval, exemplified by the difference between the variability of a first asset volume and a second asset volume. Sales volume variability quantifies the degree to which the number of sales of a product deviates from its mean values. For instance, if the average number of sales is determined to be five units per day, but over a given period (e.g., two weeks), the average number of sales increases to twenty units per day, this indicates a shift in sales volume variability.

The asset modeling module 224 can apply a specialized algorithm (e.g., a rule based logic) to the real-time operations logs (e.g., stored in the asset information database 250) and detect abnormal trends in transaction volume. This algorithm identifies significant deviations in the volume of transactions compared to historical data, enabling proactive price management. By continuously monitoring the transaction volume, the system can alert users to unusual patterns, allowing them to make timely adjustments to pricing strategies and align them with market conditions.

A shift in target price movement in terms of random length price movement refers to a change in target price in response to the event of the market changing state, such as a difference between a first target asset value and a second target asset value. For example, the market can go from a stable state to a declining market state. For instance, the target price can drop from ten dollars to eight dollars, indicating a shift in target price overall despite the length of the product.

The asset modeling module 224 can apply a specialized algorithm (e.g., a rule based logic) to the real-time operations logs (e.g., stored in the asset information database 250) and compare price performance with industry-accepted pricing indexes. For example, the asset modeling module 224 analyzes price movements across thousands of stock keeping units (SKUs) to assess internal pricing performance against the market average. The asset modeling module 224 can train the specialized algorithm on a custom dataset that includes target prices and corresponding dimensions (e.g., length, width, and/or similar features) of products over time, enabling the algorithm to identify unique patterns in target prices relative to indexed pricing. By continuously monitoring these trends, the asset modeling module 224 can detect significant deviations between current unit pricing and the industry benchmark. When such anomalies are identified, asset modeling module 224 can promptly alert subscribed users to enact proactive actions to address these market deviations.

A shift in inventory levels refers to a difference between a first inventory level and a second inventory level. For instance, under typical conditions, the company records an average sale of five units of a product per week, resulting in an average residual inventory of three units. However, in a particular week, the residual inventory surges to fifteen units, signifying an elevated inventory level that necessitates strategic measures to facilitate its sale. For a shift in inventory levels, the asset modeling module 224 can apply a specialized algorithm to dynamically evaluate the ATP (Available to Promise) levels of thousands of SKUs based on their recent sales pace. For example, the asset modeling module 224 can use this algorithm to analyze the operations logs stored in the asset information database 250. The asset modeling module 224 can configure the algorithm to continuously monitor the ATP levels and, when certain thresholds are breached, promptly alert users to take appropriate pricing and active management actions to address the inventory issue preemptively. This proactive approach allows users to manage inventory levels effectively and align them with market demands.

### Remediation Events and Processes

The asset modeling module 224 can be configured to trigger a remediation event indicating detection of abnormal KPI metrics from the analyzed operations logs. For example, the asset modeling module 224 can compare each determined KPI against a stability threshold that represents acceptable indicator values (e.g., a single value, a range of values, a dynamic value, and/or the like) at which fluctuations of operational attributes (e.g., sales price, market price, and/or the like) for a resource unit are relatively stable (e.g., ignoring and/or mitigating transient noise patterns). In response to determining a KPI that fails to satisfy the stability threshold, the asset modeling module 224 can generate and transmit a notification alert for display at a user interface of a subscribing end user (e.g., a visual marking, a dynamic user interactable element, and/or the like). For example, the asset modeling module 224 can transmit a notification alert to the user in response to detecting a significant shift in the actual asset value versus the target asset value such that the rolling average of the ratio between actual and target price shifts more than a predefined stability threshold (e.g., five percent deviation).

In another example, the asset modeling module 224 can generate a particular metric value based on a particular time period, and the particular time period is user selected. For example, in response to detecting that the ratio between the daily volume of a product and the user-selected time period (e.g., four-week) daily volume of a product shifts more than a corresponding stability threshold value (e.g., five percent), the asset modeling module 224 can transmit a notification alert to the user.

In another example, in response to detecting a shift in the average target asset value has exceeded a threshold, the asset modeling module 224 can initiate a remediation event, which includes transmitting a notification alert for the overall market change to the user.

In another example, in response to detecting the volume of a product has exceeded a stability threshold, the asset modeling module 224 can initiate a remediation event that includes transmitting a notification alert for the inventory issues to the user. As a continuing example, the stability threshold can be set to the amount of inventory needed for three weeks. In response to detecting an available quantity of unused assets exceeding three weeks supply, the asset modeling module 224 can transmit a notification alert to a sales manager for remediation. Accordingly, the sales manager is then able to target the excess inventory stock. In another example, the stability threshold can be set to an amount higher than the average amount of product stored in inventory. For example, on average, the company sells five units of a product, leaving on average only three units in inventory weekly. The threshold can be set to any number higher than three to trigger an alert.

The asset modeling module 224 can be configured to perform automatic remediation processes in response to detecting abnormal trends in KPIs for an allocable resource unit. For example, the asset modeling module 224 can determine a recommended adjustment to the current target unit value (e.g., target sales price) set for the resource unit. To determine an appropriate adjustment value, the asset modeling module 224 can generate analytical artifacts to approximate future operational attributes (e.g., realized sale price, market sale price, and/or the like) for the resource unit. For example, the asset modeling module 224 can generate a forecasting time-series dataset that predicts a set of future operational attributes (e.g., future market sale price, future realized sale price, and/or the like) based on existing operation logs (e.g., valuation records, distribution records, logistics records) for the resource unit. In some implementations, the asset modeling module 224 can apply a machine learning model (e.g., a recurrent neural network) to approximate the time-series forecast of predicted operational attributes of the resource unit. Accordingly, the asset modeling module 224 can use the predicted future operational attributes (e.g., future sales information) of the forecasting time-series data to estimate an appropriate adjustment to the target unit value.

In some implementations, the asset modeling module 224 can determine granular adjustment values for the target unit value. For example, the asset modeling module 224 can extract and segregate operation logs (e.g., valuation records, distribution records, logistics records, and/or the like) of an allocable resource unit into one or more distinct categories that represent groups of receiving end users (e.g., buyers and/or consumers of an asset) that share profiling attributes (e.g., demographic information, purchasing history, and/or the like). Accordingly, the asset modeling module 224 can generate an individual set of adjustment values for each category based on operational attributes (e.g., realized sale price, market sale price, and/or the like) of the operation logs assigned to the category. In some implementations, the asset modeling module 224 can evaluate a combination of the granular adjustment values and the forecasting time-series data samples to determine an adjusted target unit value (e.g., a modified target sale price) for the resource unit or asset.

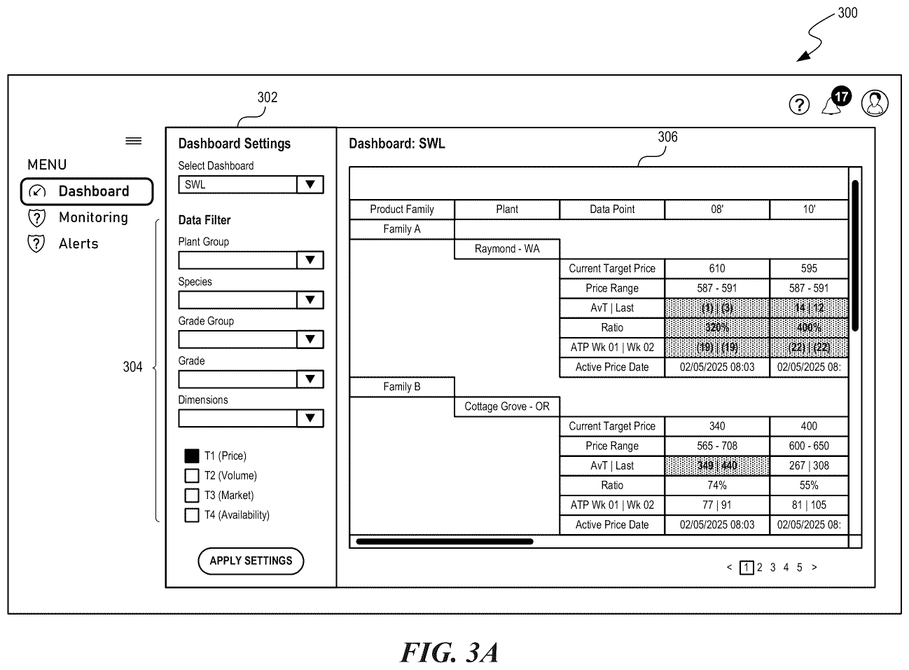

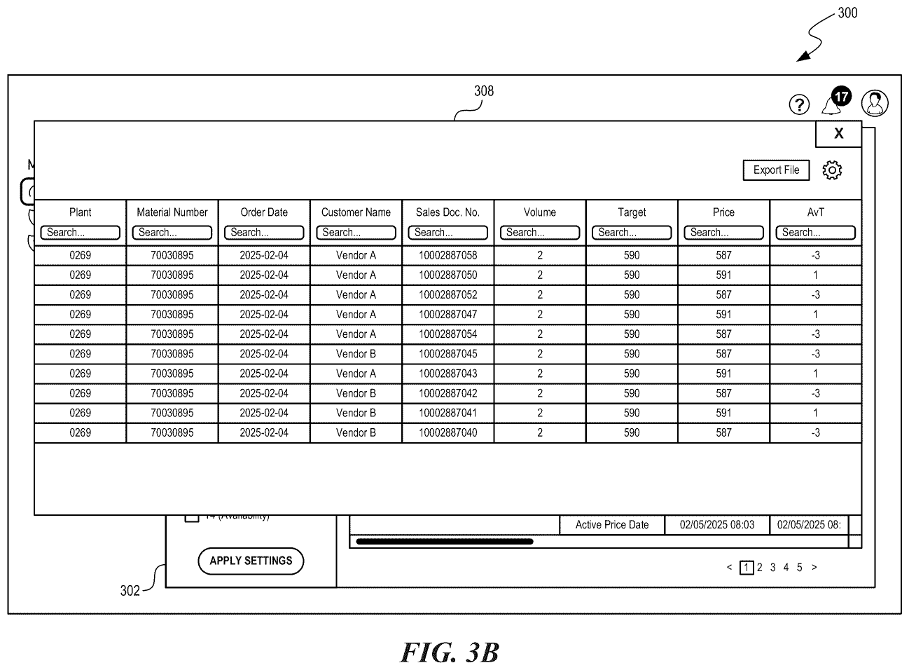

FIGS. 3A-3B show an example graphical user interface 300 (“interface 300”) that demonstrates aspects of a resource management interface of the resource management system 200 of FIG. 2 in accordance with some implementations of the present technology. Interface 300 is implemented using components of the example computer system 100 illustrated and described in more detail with reference to FIG. 1. Likewise, implementations of interface 300 can include different and/or additional components or can be connected in different ways. Interface 300 is a visual interface that allows end users (e.g., a third-party vendor, a manufacturer, and/or the like) to interact with electronic devices using graphical elements (e.g., windows, icons, buttons, and/or the like) rather than text-based commands.

As shown in FIG. 3A, the interface 300 includes user interactable elements (e.g., an application widget, a website page, and/or the like) for dashboard settings 302 and a data matrix 306. The dashboard settings 302 element further includes a set of data filter options 304 that can adjust the information (e.g., types of operational attributes) displayed on the data matrix 306. The data matrix 306 displays a standardized format (e.g., a tabular view) for displaying evaluated KPIs for individual resource units. For illustrative purposes, the data matrix 306 is presented in tabular form. An ordinary person skilled in the art will appreciate that the graphical arrangement of the data matrix 306 is not strictly limited to the illustrated example and can be dynamically adjusted to different shapes and forms (e.g., a chart, a graph, and/or the like) that characterize and/or accentuate relationship patterns between presented metrics (e.g., operational attributes).

The data matrix 306 of FIG. 3A illustrates a pair of example resource units for lumber assets actively monitored by the resource management system 200. The first resource unit corresponds to identifiable tags for a first product family (“Family A”) and a first plant identifier (“Raymond—WA”) while the second resource unit corresponds to separate identifiable tags for a second product family (“Family B”) and a second plant identifier (“Cottage Grove—OR”). As shown, the interface 300 arranges the data matrix 306 to display a visual separation between each example resource unit. The example data matrix 306 of FIG. 3A illustrates an embedded matrix, or miniature table, that relates measured KPIs for the resource unit (e.g., row-wise aligned) to one or more data filters (e.g., column-wise aligned). Accordingly, the interface 300 configures each intersecting cell element of the embedded matrix to display the measured KPI value (e.g., current target price, price range, AvT, ratio, ATP, and active price date) for the corresponding data filter (e.g., lumber dimensions). The interface 300 further configures the individual cell elements of the embedded data matrix to display a distinguishing visual marker (e.g., a color, a brightness, a unique graphical element, and/or the like) that indicates abnormal measurements for the corresponding KPI value (e.g., fails to satisfy the stability threshold).

As shown in FIG. 3B, the interface 300 includes an enumeration window 308 that is visually separated from the dashboard view (e.g., floating above the dashboard settings 302, data filter options 304, and the data matrix 306). Interface 300 presents a custom user interface component (e.g., an application widget, a website page, and/or the like) for presenting an enumerated list of relevant operations logs (e.g., individual valuation records, distribution records, logistics records, and/or the like) and/or attributes (e.g., target unit value, sales price value, AvT, and/or the like).

The enumerated window 308 displays a standardized format (e.g., a tabular view) for displaying each recorded operations log for the allocable resource unit and the specified KPI. For illustrative purposes, the data structure of the enumerated window 308 is presented in tabular form. An ordinary person skilled in the art will appreciate that the graphical arrangement of the enumerated window 308 is not strictly limited to the illustrated example and can be dynamically adjusted to different shapes and forms (e.g., an image view, an individual card, navigational folders, and/or the like) that streamlines review of the identified operations logs. In some implementations, the enumerated window 308 is configured to include a filtering mechanism (e.g., a categorical search bar) for obtaining a subset of operations logs that satisfy a queried criteria (e.g., a keyword, a variable type, and/or the like). In some implementations, the enumerated window 308 is configured to export information associated with the displayed operations logs to a standardized digital file format (e.g., Microsoft Excel, Google Spreadsheets, Comma Separated Values, and/or the like).

In some implementations, the interface 300 can be configured to display custom visual elements that present recommended user adjustments (e.g., modifications to target unit values), generated analytical content (e.g., forecasting time-series datasets, end user-based adjustment values, and/or the like), and/or human-readable narratives explaining one or more features presented on the interface 300 (e.g., abnormal KPI measurements shown in data matrix 306). The interface 300 can be configured to display the custom visual elements within the dashboard view (e.g., data matrix 306), the granular operations view (e.g., enumeration window 308), or on a separate user interface element (e.g., a separate pop out window).

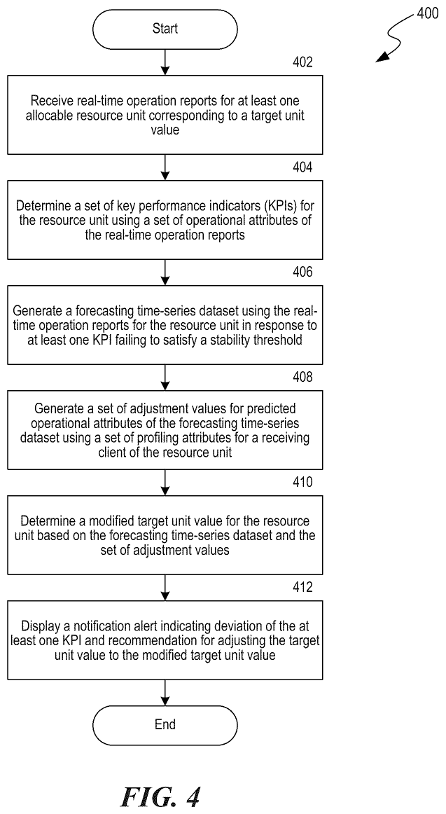

FIG. 4 is a flow diagram that illustrates an example process 400 for managing distribution operations for resource units in accordance with some implementations of the disclosed technology. The process 400 can be performed by a system (e.g., resource management system 200) configured to identify, and evaluate, KPIs of operational attributes for distributing allocable resource units. In one example, the system includes at least one hardware processor and at least one non-transitory memory storing instructions, which, when executed by the at least one hardware processor, cause the system to perform the process 400. In another example, the system includes a non-transitory, computer-readable storage medium comprising instructions recorded thereon, which, when executed by at least one data processor, cause the system to perform the process 400.

At block 402, the system can receive operation logs (e.g., a pricing record, a transaction quota, a sales data, and/or the like) for at least one allocable resource unit (e.g., an asset, a stock unit, an exchangeable good, and/or the like) corresponding to a target unit value (e.g., target sales price, manufacturer's suggested retail price (MSRP), and/or the like). For example, the system can use an application programming interface (API) to probe and/or capture real-time operation logs for a particular resource unit from a remote database (e.g., an open digital marketplace, a central repository, and/or the like). In some implementations, the system can obtain operation logs that include a set of operational attributes pertaining to distribution of the at least one allocable resource unit. In some implementations, the system can obtain operation logs that include a set of profiling attributes pertaining to a receiving end user (e.g., a marketplace consumer, a contract purchaser, and/or the like) of the at least one allocable resource unit.

The set of operational attributes for distribution of the at least one allocable resource unit can comprise a standard unit value (e.g., a base price), a target unit value (e.g., a target sales price, MSRP, and/or the like), a realized unit value (e.g., actual transaction/sale price), a distributive resource value (e.g., a market price), an alternative resource unit value (e.g., price of equivalent item, a competing price, and/or the like), a discounted unit value, a promotional unit value, a penalty value (e.g., fees), a taxation value, a maintenance value, a surplus value, a quantity of resource distributions (e.g., a number of sales), a quantity of available resource units (e.g., an inventory count), a variable attribute of allocable resource units (e.g., indefinite asset properties, random lumber length index, and/or the like), a variable attribute of resource unit distributions (e.g., variability in transaction data), a logistics parameter of resource units, and/or any combination thereof.

In some implementations, the system can receive operation logs that comprise a standard valuation profile (e.g., a pricing record), an individualized valuation profile (e.g., a transaction quota), a manifest of available resource units (e.g., an inventory), a historical log of unit transactions, a discounted valuation ruleset, a promotional valuation ruleset, a statistical summary for the at least one allocable resource unit, or a combination thereof.

At block 404, the system can determine a set of KPIs for the at least one allocable resource unit. For example, the system can evaluate the set of operational attributes (e.g., actual sales price) of the real-time operation logs to determine one or more KPIs (e.g., actual sales price vs. target sales price (AvT)) for the allocable resource unit. The set of KPIs can comprise a change in resource unit value (e.g., change in sales price), a comparative value of realized unit value to the target unit value (e.g., AvT), a range of resource unit values (e.g., recorded range of sales/transaction prices), a change in distributive unit value (e.g., change in market price), a comparative value of realized unit value to the distributive unit value (e.g., actual sales price vs. market sales price (AvM)), a change in quantity of resource unit distributions (e.g., shift in volume of sales/transactions), a change in quantity of available resource units (e.g., shift in inventory availability and/or production), a change in variable attribute of resource units, a change in logistics parameter of resource units, and/or any combination thereof.

At block 406, the system can evaluate the determined set of KPIs for the at least one allocable resource unit to determine indications of a volatile valuation condition. For example, the system can compare the set of KPIs to one or more stability thresholds representing acceptable ranges of fluctuations in KPI values (e.g., a margin of error) that account for transient noise (e.g., natural market pricing volatility). In additional or alternative implementations, the system can compare the set of KPIs to one or more abnormality thresholds representing probabilistic ranges (e.g., confidence bands) for significant fluctuations in KPI values and/or presence of shifting valuation patterns. In response to at least one KPI from the set of KPIs failing to satisfy the stability threshold, the system can generate a forecasting dataset that predicts operational attributes for the at least one allocable resource unit over a brief time interval. For example, the system can use a machine learning model to analyze historical operational attributes (e.g., prior transaction price of resource units) of the real-time operation logs to predict a time-series sequence of expected operational attributes (e.g., future transaction price of resource units).

At block 408, the system can generate a set of adjustment values (e.g., price adjustments) for the predicted operational attributes (e.g., predicted future sales prices) of the forecasting time-series dataset. For example, the system can use a machine learning model (e.g., a second machine learning model) to analyze the set of profiling attributes (e.g., of the operation logs) for the receiving end users of the at least one allocable resource unit and predict one or more adjustment values that change the predicted operational attributes of the forecasting time-series dataset.

In some implementations, the system can generate additional adjustment values for the forecasting time-series dataset using profiling attributes of receiving end users. The system can group the real-time operation logs into a set of end user categories (e.g., a consumer type, a user profile, and/or the like) based on the profiling attributes of the receiving end user of the at least one allocable resource unit. For example, the system can segregate the real-time operation logs into a plurality of end user categories such that each end user category represents one or more receiving end users that share similar profiling attributes. In some implementations, the system can use the second machine learning model to generate a unique set of adjustment values for each end user category using the profiling attributes of member receiving end users (e.g., of the corresponding end user category).

In some implementations, the system can determine multiple sets of adjustment values. For example, the system can access a manifest comprising logistical information for available supply of the at least one allocable resource unit (e.g., a stock-keeping inventory, manufacturing purchase order, and/or the like). Accordingly, the system can use a third machine learning model to analyze the logistical information of the manifest and generate a second set of adjustment values for the predicted operational attributes of the forecasting time-series dataset.

At block 410, the system can determine a modified target unit value for the at least one allocable resource unit based on the forecasting time-series dataset and the set of adjustment values. As an example, the system can apply statistical inference algorithms (e.g., a linear trend fit model, a machine learning model, and/or the like) that analyzes the combination of the forecasting time-series dataset and the set of adjustment values to approximate the modifier target unit value. As described herein, the modified target unit value represents a recommended adjustment to the target unit value (e.g., target sales price) for the allocable resource unit to maintain the set of KPIs within desired operating conditions (e.g., satisfying the stability thresholds).

In some implementations, the system can determine a unique modified target unit value for each end user category. For example, the system can use a machine learning model to analyze the forecasting time-series dataset and the unique set of adjustment values for the end user category and generate individual modified target unit values for each end user categorical group. In some implementations, the system can update the modified target unit value based on multiple sets of adjustment values. For example, the system can apply the machine learning model on the forecasting time-series dataset, the first set of adjustment values, and the second set of adjustment values to generate the modified target unit value.

At block 412, the system can display (e.g., at a user interface) a notification alert indicating deviation of the identified at least one KPI and a recommendation for adjusting the target unit value (e.g., to the modified target unit value). In some implementations, the system can configure the notification alert to include a user interactive element (e.g., a selectable button) that, when selected, automatically updates the target unit value to the modified target unit value. As a result, the system can process incoming operation logs to determine KPI measurements based on the modified target unit value.

In some implementations, the system can cause (e.g., formulate and execute a context-based prompt) a generative machine learning model (e.g., a large language model) to generate a human-readable narrative that identifies a subset of operational attributes for the at least one allocable resource unit (e.g., from the operation logs) that contribute and/or correlate to the modified target unit value. For example, the system can use a generative machine learning model to generate a detailed explanation for the recommendation of adjusting the target unit value to the modified target value. Accordingly, the system can display (e.g., at the user interface) the human-readable narrative within the user interactive element that recommends adjusting the target unit value to the modified target unit value.

In some implementations, the system can receive (e.g., from the user interface) a user selection for a subset of available (e.g., targeted) operational attributes for processing the real-time operation logs. For example, the system can receive a user selection to filter for a specified subset of operational attributes when analyzing incoming operation logs. Using the selected subset of available operational attributes for the real-time operation logs, the system can generate (e.g., via the first machine learning model) a second forecasting time-series dataset. Accordingly, the system can update the modified target unit value based on the second forecasting time-series dataset and the set of adjustment values.

In some implementations, the system can display (e.g., at the user interface) the operational attributes and the KPIs of the real-time operation logs in a standardized format enabling of comparison of the measured metrics. For example, the system can display a tabular figure (e.g., a matrix) that organizes the KPIs for the operation logs row-wise and the operational attributes of the operation logs column-wise. Accordingly, the system can configure each intersection of the tabular figure to comprise a cell element that presents a selected KPI (e.g., row entity) for a corresponding operational attribute (e.g., column entity). In additional or alternative implementations, the system can configure the tabular figure to organize the KPIs column-wise and the operational attributes row-wise. In response to a user selection of at least one cell element from the displayed tabular figure, the system can display (e.g., at the user interface) an enumerated list of operation logs comprising the operational attribute of the selected at least one cell element. In some implementations, the system can configure each cell element of the tabular figure corresponding to an anomalous KPI to display a distinguishing visual marker (e.g., a highlighted color) indicating failure to satisfy the stability threshold.

### Machine Learning Models

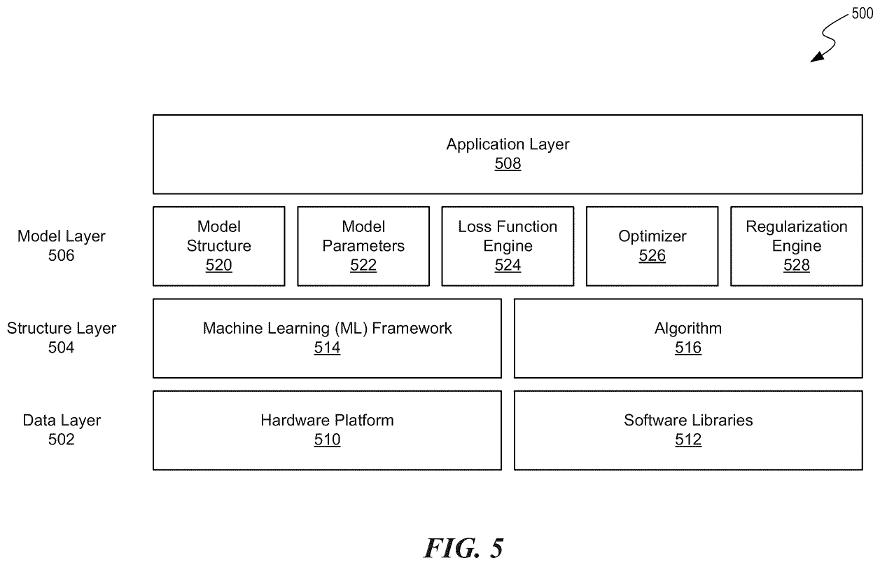

FIG. 5 illustrates a layered architecture of an artificial intelligence (AI) system 500 that can implement the machine learning (ML) models of the resource management system 200 of FIG. 2, in accordance with some implementations of the present technology. Example ML models can include the models executed by the asset modeling module 223. Accordingly, the ML models stored in the ML repository 270 can include one or more components of the AI system 500.

As shown, the AI system 500 can include a set of layers, which conceptually organize elements within an example network topology for the AI system's architecture to implement a particular AI model. Generally, an AI model is a computer-executable program implemented by the AI system 500 that analyses data to make predictions. Information can pass through each layer of the AI system 500 to generate outputs for the AI model. The layers can include a data layer 502, a structure layer 504, a model layer 506, and an application layer 508. The algorithm 516 of the structure layer 504 and the model structure 520 and model parameters 522 of the model layer 506 together form an example AI model. The optimizer 526, loss function engine 524, and regularization engine 528 work to refine and optimize the AI model, and the data layer 502 provides resources and support for application of the AI model by the application layer 508.

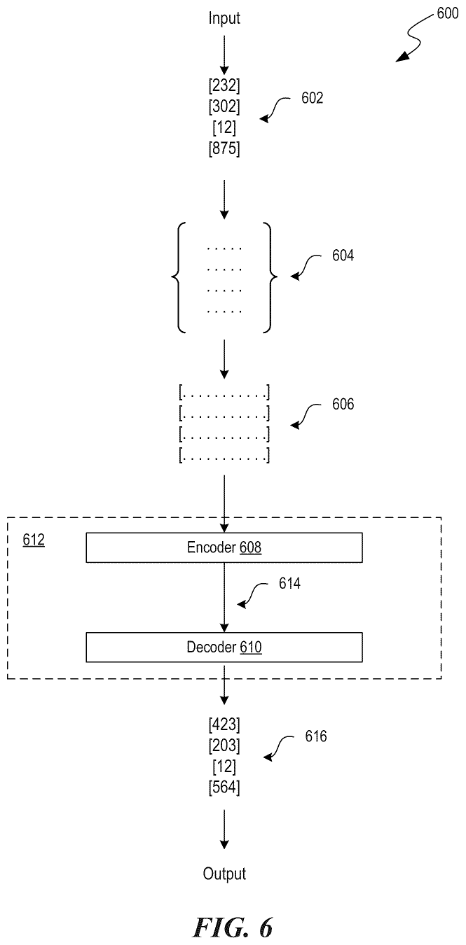

The data layer 502 acts as the foundation of the AI system 500 by preparing data for the AI model. As shown, the data layer 502 can include two sub-layers: a hardware platform 510 and one or more software libraries 512. The hardware platform 510 can be designed to perform operations for the AI model and include computing resources for storage, memory, logic and networking, such as the resources described in relation to FIGS. 4 and 6. The hardware platform 510 can process amounts of data using one or more servers. The servers can perform backend operations such as matrix calculations, parallel calculations, machine learning (ML) training, and the like. Examples of servers used by the hardware platform 510 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors, such as application specific integrated circuits (ASIC). GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 510 can include computing resources, (e.g., servers, memory, etc.) offered by a cloud services provider. The hardware platform 510 can also include computer memory for storing data about the AI model, application of the AI model, and training data for the AI model. The computer memory can be a form of random-access memory (RAM), such as dynamic RAM, static RAM, and non-volatile RAM.

The software libraries 512 can be thought of suites of data and programming code, including executables, used to control the computing resources of the hardware platform 510. The programming code can include low-level primitives (e.g., fundamental language elements) that form the foundation of one or more low-level programming languages, such that servers of the hardware platform 510 can use the low-level primitives to carry out specific operations. The low-level programming languages do not require much, if any, abstraction from a computing resource's instruction set architecture, allowing them to run quickly with a small memory footprint. Examples of software libraries 512 that can be included in the AI system 500 include INTEL Math Kernel Library, NVIDIA cuDNN, EIGEN, and OpenBLAS.

The structure layer 504 can include an ML framework 514 and an algorithm 516. The ML framework 514 can be thought of as an interface, library, or tool that allows users to build and deploy the AI model. The ML framework 514 can include an open-source library, an application programming interface (API), a gradient-boosting library, an ensemble method, and/or a deep learning toolkit that work with the layers of the AI system facilitate development of the AI model. For example, the ML framework 514 can distribute processes for application or training of the AI model across multiple resources in the hardware platform 510. The ML framework 514 can also include a set of pre-built components that have the functionality to implement and train the AI model and allow users to use pre-built functions and classes to construct and train the AI model. Thus, the ML framework 514 can be used to facilitate data engineering, development, hyperparameter tuning, testing, and training for the AI model. Examples of ML frameworks 514 that can be used in the AI system 500 include TENSORFLOW, PYTORCH, SCIKIT-LEARN, KERAS, LightGBM, RANDOM FOREST, and AMAZON WEB SERVICES.

The algorithm 516 can be an organized set of computer-executable operations used to generate output data from a set of input data and can be described using pseudocode. The algorithm 516 can include complex code that allows the computing resources to learn from new input data and create new/modified outputs based on what was learned. In some implementations, the algorithm 516 can build the AI model through being trained while running computing resources of the hardware platform 510. This training allows the algorithm 516 to make predictions or decisions without being explicitly programmed to do so. Once trained, the algorithm 516 can run at the computing resources as part of the AI model to make predictions or decisions, improve computing resource performance, or perform tasks. The algorithm 516 can be trained using supervised learning, unsupervised learning, semi-supervised learning, and/or reinforcement learning.

Using supervised learning, the algorithm 516 can be trained to learn patterns (e.g., map input data to output data) based on labeled training data. The training data may be labeled by an external user or operator. For instance, a user may collect a set of training data, such as by capturing data from sensors, images from a camera, outputs from a model, and the like. Furthermore, training data can include pre-processed data generated by various engines of the resource management system 200 described in relation to FIG. 2. The user may label the training data based on one or more classes and trains the AI model by inputting the training data to the algorithm 516. The algorithm determines how to label the new data based on the labeled training data. The user can facilitate collection, labeling, and/or input via the ML framework 514. In some instances, the user may convert the training data to a set of feature vectors for input to the algorithm 516. Once trained, the user can test the algorithm 516 on new data to determine if the algorithm 516 is predicting accurate labels for the new data. For example, the user can use cross-validation methods to test the accuracy of the algorithm 516 and retrain the algorithm 516 on new training data if the results of the cross-validation are below an accuracy threshold.

Supervised learning can involve classification and/or regression. Classification techniques involve teaching the algorithm 516 to identify a category of new observations based on training data and are used when input data for the algorithm 516 is discrete. Said differently, when learning through classification techniques, the algorithm 516 receives training data labeled with categories (e.g., classes) and determines how features observed in the training data (e.g., various claim elements, policy identifiers, tokens extracted from unstructured data) relate to the categories (e.g., risk propensity categories, claim leakage propensity categories, complaint propensity categories). Once trained, the algorithm 516 can categorize new data by analyzing the new data for features that map to the categories. Examples of classification techniques include boosting, decision tree learning, genetic programming, learning vector quantization, k-nearest neighbor (k-NN) algorithm, and statistical classification.

Regression techniques involve estimating relationships between independent and dependent variables and are used when input data to the algorithm 516 is continuous. Regression techniques can be used to train the algorithm 516 to predict or forecast relationships between variables. To train the algorithm 516 using regression techniques, a user can select a regression method for estimating the parameters of the model. The user collects and labels training data that is input to the algorithm 516 such that the algorithm 516 is trained to understand the relationship between data features and the dependent variable(s). Once trained, the algorithm 516 can predict missing historic data or future outcomes based on input data. Examples of regression methods include linear regression, multiple linear regression, logistic regression, regression tree analysis, least squares method, and gradient descent. In an example implementation, regression techniques can be used, for example, to estimate and fill-in missing data for machine-learning based pre-processing operations.

Under unsupervised learning, the algorithm 516 learns patterns from unlabeled training data. In particular, the algorithm 516 is trained to learn hidden patterns and insights of input data, which can be used for data exploration or for generating new data. Here, the algorithm 516 does not have a predefined output, unlike the labels output when the algorithm 516 is trained using supervised learning. Said another way, unsupervised learning is used to train the algorithm 516 to find an underlying structure of a set of data, group the data according to similarities, and represent that set of data in a compressed format.

A few techniques can be used in supervised learning: clustering, anomaly detection, and techniques for learning latent variable models. Clustering techniques involve grouping data into different clusters that include similar data, such that other clusters contain dissimilar data. For example, during clustering, data with possible similarities remain in a group that has less or no similarities to another group. Examples of clustering techniques density-based methods, hierarchical based methods, partitioning methods, and grid-based methods. In one example, the algorithm 516 may be trained to be a k-means clustering algorithm, which partitions n observations in k clusters such that each observation belongs to the cluster with the nearest mean serving as a prototype of the cluster. Anomaly detection techniques are used to detect previously unseen rare objects or events represented in data without prior knowledge of these objects or events. Anomalies can include data that occur rarely in a set, a deviation from other observations, outliers that are inconsistent with the rest of the data, patterns that do not conform to well-defined normal behavior, and the like. When using anomaly detection techniques, the algorithm 516 may be trained to be an Isolation Forest, local outlier factor (LOF) algorithm, or K-nearest neighbor (k-NN) algorithm. Latent variable techniques involve relating observable variables to a set of latent variables. These techniques assume that the observable variables are the result of an individual's position on the latent variables and that the observable variables have nothing in common after controlling for the latent variables. Examples of latent variable techniques that may be used by the algorithm 516 include factor analysis, item response theory, latent profile analysis, and latent class analysis.

The model layer 506 implements the AI model using data from the data layer and the algorithm 516 and ML framework 514 from the structure layer 504, thus enabling decision-making capabilities of the AI system 500. The model layer 506 includes a model structure 520, model parameters 522, a loss function engine 524, an optimizer 526, and a regularization engine 528.

The model structure 520 describes the architecture of the AI model of the AI system 500. The model structure 520 defines the complexity of the pattern/relationship that the AI model expresses. Examples of structures that can be used as the model structure 520 include decision trees, support vector machines, regression analyses, Bayesian networks, Gaussian processes, genetic algorithms, and artificial neural networks (or, simply, neural networks). The model structure 520 can include a number of structure layers, a number of nodes (or neurons) at each structure layer, and activation functions of each node. Each node's activation function defines how to node converts data received to data output. The structure layers may include an input layer of nodes that receive input data, an output layer of nodes that produce output data. The model structure 520 may include one or more hidden layers of nodes between the input and output layers. The model structure 520 can be an Artificial Neural Network (or, simply, neural network) that connects the nodes in the structured layers such that the nodes are interconnected. Examples of neural networks include Feedforward Neural Networks, convolutional neural networks (CNNs), Recurrent Neural Networks (RNNs), Autoencoder, and Generative Adversarial Networks (GANs).

The model parameters 522 represent the relationships learned during training and can be used to make predictions and decisions based on input data. The model parameters 522 can weight and bias the nodes and connections of the model structure 520. For instance, when the model structure 520 is a neural network, the model parameters 522 can weight and bias the nodes in each layer of the neural networks, such that the weights determine the strength of the nodes and the biases determine the thresholds for the activation functions of each node. The model parameters 522, in conjunction with the activation functions of the nodes, determine how input data is transformed into desired outputs. The model parameters 522 can be determined and/or altered during training of the algorithm 516.

The loss function engine 524 can determine a loss function, which is a metric used to evaluate the AI model's performance during training. For instance, the loss function engine 524 can measure the difference between a predicted output of the AI model and the actual output of the AI model and is used to guide optimization of the AI model during training to minimize the loss function. The loss function may be presented via the ML framework 514, such that a user can determine whether to retrain or otherwise alter the algorithm 516 if the loss function is over a threshold. In some instances, the algorithm 516 can be retrained automatically if the loss function is over the threshold. Examples of loss functions include a binary-cross entropy function, hinge loss function, regression loss function (e.g., mean square error, quadratic loss, etc.), mean absolute error function, smooth mean absolute error function, log-cosh loss function, and quantile loss function.

The optimizer 526 adjusts the model parameters 522 to minimize the loss function during training of the algorithm 516. In other words, the optimizer 526 uses the loss function generated by the loss function engine 524 as a guide to determine what model parameters lead to the most accurate AI model. Examples of optimizers include Gradient Descent (GD), Adaptive Gradient Algorithm (AdaGrad), Adaptive Moment Estimation (Adam), Root Mean Square Propagation (RMSprop), Radial Base Function (RBF) and Limited-memory BFGS (L-BFGS). The type of optimizer 526 used may be determined based on the type of model structure 520 and the size of data and the computing resources available in the data layer 502.

The regularization engine 528 executes regularization operations. Regularization is a technique that prevents over-and under-fitting of the AI model. Overfitting occurs when the algorithm 516 is overly complex and too adapted to the training data, which can result in poor performance of the AI model. Underfitting occurs when the algorithm 516 is unable to recognize even basic patterns from the training data such that it cannot perform well on training data or on validation data. The optimizer 526 can apply one or more regularization techniques to fit the algorithm 516 to the training data properly, which helps constraint the resulting AI model and improves its ability for generalized application. Examples of regularization techniques include lasso (L1) regularization, ridge (L2) regularization, and elastic (L1 and L2 regularization).

The application layer 508 describes how the AI system 500 is used to solve problem or perform tasks. In an example implementation, the application layer 508 can be communicatively coupled (e.g., display application data, receive user input, and/or the like) to an interactable user interface of the resource management system 200 of FIG. 2.

### Transformer for Neural Network

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others.

DNNs are often used as ML-based models for modeling complex behaviors (e.g., human language, image recognition, object classification) in order to improve the accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. Training data may be annotated with ground truth labels (e.g., each data entry in the training dataset may be paired with a label), or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (also referred to as update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publically-available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to a ML-based language model, there could exist non-ML language models. In the present disclosure, the term “language model” may be used as shorthand for an ML-based language model (i.e., a language model that is implemented using a neural network or other ML architecture), unless stated otherwise. For example, unless stated otherwise, the “language model” encompasses LLMs.

A language model may use a neural network (typically a DNN) to perform natural language processing (NLP) tasks. A language model may be trained to model how words relate to each other in a textual sequence, based on probabilities. A language model may contain hundreds of thousands of learned parameters or in the case of a large language model (LLM) may contain millions or billions of learned parameters or more. As non-limiting examples, a language model can generate text, translate text, summarize text, answer questions, write code (e.g., Phyton, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

In recent years, there has been interest in a type of neural network architecture, referred to as a transformer, for use as language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

FIG. 6 is a block diagram of an example transformer 612 that can implement aspects of the present technology. A transformer is a type of neural network architecture that uses self-attention mechanisms to generate predicted output based on input data that has some sequential meaning (i.e., the order of the input data is meaningful, which is the case for most text input). Self-attention is a mechanism that relates different positions of a single sequence to compute a representation of the same sequence. Although transformer-based language models are described herein, it should be understood that the present disclosure may be applicable to any machine learning (ML)-based language model, including language models based on other neural network architectures such as recurrent neural network (RNN)-based language models.

The transformer 612 includes an encoder 608 (which can comprise one or more encoder layers/blocks connected in series) and a decoder 610 (which can comprise one or more decoder layers/blocks connected in series). Generally, the encoder 608 and the decoder 610 each include a plurality of neural network layers, at least one of which can be a self-attention layer. The parameters of the neural network layers can be referred to as the parameters of the language model.

The transformer 612 can be trained to perform certain functions on a natural language input. For example, the functions include summarizing existing content, brainstorming ideas, writing a rough draft, fixing spelling and grammar, and translating content. Summarizing can include extracting key performances from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some embodiments, the transformer 612 is trained to perform certain functions on other input formats than natural language input. For example, the input can include objects, images, audio content, or video content, or a combination thereof.

The transformer 612 can be trained on a text corpus that is labeled (e.g., annotated to indicate verbs, nouns) or unlabeled. Large language models (LLMs) can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input). FIG. 6 illustrates an example of how the transformer 612 can process textual input data. Input to a language model (whether transformer-based or otherwise) typically is in the form of natural language that can be parsed into tokens. It should be appreciated that the term “token” in the context of language models and Natural Language Processing (NLP) has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some examples, a token can correspond to a portion of a word.

For example, the word “greater” can be represented by a token for [great] and a second token for [er]. In another example, the text sequence “write a summary” can be parsed into the segments [write], 2, and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 6, a short sequence of tokens 602 corresponding to the input text is illustrated as input to the transformer 612. Tokenization of the text sequence into the tokens 602 can be performed by some pre-processing tokenization module such as, for example, a byte-pair encoding tokenizer (the “pre” referring to the tokenization occurring prior to the processing of the tokenized input by the LLM), which is not shown in FIG. 6 for simplicity. In general, the token sequence that is inputted to the transformer 612 can be of any length up to a maximum length defined based on the dimensions of the transformer 612. Each token 602 in the token sequence is converted into an embedding vector 606 (also referred to simply as an embedding 606). An embedding 606 is a learned numerical representation (such as, for example, a vector) of a token that captures some semantic meaning of the text segment represented by the token 602. The embedding 606 represents the text segment corresponding to the token 602 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 606 corresponding to the “write” token will be closer to another embedding corresponding to the “jot down” token in the vector space as compared to the distance between the embedding 606 corresponding to the “write” token and another embedding corresponding to the “summary” token.

The vector space can be defined by the dimensions and values of the embedding vectors. Various techniques can be used to convert a token 602 to an embedding 606. For example, another trained ML model can be used to convert the token 602 into an embedding 606. In particular, another trained ML model can be used to convert the token 602 into an embedding 606 in a way that encodes additional information into the embedding 606 (e.g., a trained ML model can encode positional information about the position of the token 602 in the text sequence into the embedding 606). In some examples, the numerical value of the token 602 can be used to look up the corresponding embedding in an embedding matrix 604 (which can be learned during training of the transformer 612).

The generated embeddings 606 are input into the encoder 608. The encoder 608 serves to encode the embeddings 606 into feature vectors 614 that represent the latent features of the embeddings 606. The encoder 608 can encode positional information (i.e., information about the sequence of the input) in the feature vectors 614. The feature vectors 614 can have very high dimensionality (e.g., on the order of thousands or tens of thousands), with each element in a feature vector 614 corresponding to a respective feature. The numerical weight of each element in a feature vector 614 represents the importance of the corresponding feature. The space of all possible feature vectors 614 that can be generated by the encoder 608 can be referred to as the latent space or feature space.

Conceptually, the decoder 610 is designed to map the features represented by the feature vectors 614 into meaningful output, which can depend on the task that was assigned to the transformer 612. For example, if the transformer 612 is used for a translation task, the decoder 610 can map the feature vectors 614 into text output in a target language different from the language of the original tokens 602. Generally, in a generative language model, the decoder 610 serves to decode the feature vectors 614 into a sequence of tokens. The decoder 610 can generate output tokens 616 one by one. Each output token 616 can be fed back as input to the decoder 610 in order to generate the next output token 616. By feeding back the generated output and applying self-attention, the decoder 610 is able to generate a sequence of output tokens 616 that has sequential meaning (e.g., the resulting output text sequence is understandable as a sentence and obeys grammatical rules). The decoder 610 can generate output tokens 616 until a special [EOT] token (indicating the end of the text) is generated. The resulting sequence of output tokens 616 can then be converted to a text sequence in post-processing. For example, each output token 616 can be an integer number that corresponds to a vocabulary index. By looking up the text segment using the vocabulary index, the text segment corresponding to each output token 616 can be retrieved, the text segments can be concatenated together, and the final output text sequence can be obtained.

In some examples, the input provided to the transformer 612 includes instructions to perform a function on an existing text. In some examples, the input provided to the transformer includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text. For example, the input can include the question “What is the weather like in Australia?” and the output can include a description of the weather in Australia.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as, for example, the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ a plurality of processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via its API. As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Computer System

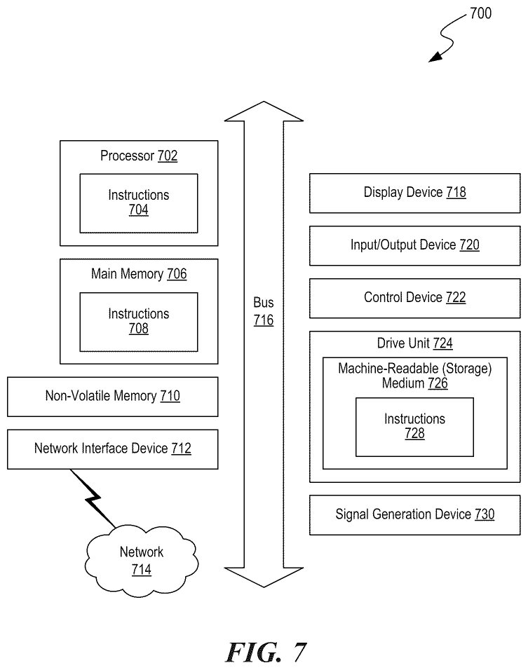

FIG. 7 is a block diagram that illustrates an example of a computer system 700 in which at least some operations described herein can be implemented. As shown, the computer system 700 can include: one or more processors 702, main memory 706, non-volatile memory 710, a network interface device 712, a video display device 718, an input/output device 720, a control device 722 (e.g., keyboard and pointing device), a drive unit 724 that includes a machine-readable (storage) medium 726, and a signal generation device 730 that are communicatively connected to a bus 716. The bus 716 represents one or more physical buses and/or point-to-point connections that are connected by appropriate bridges, adapters, or controllers. Various common components (e.g., cache memory) are omitted from FIG. 7 for brevity. Instead, the computer system 700 is intended to illustrate a hardware device on which components illustrated or described relative to the examples of the figures and any other components described in this specification can be implemented.

The computer system 700 can take any suitable physical form. For example, the computing system 700 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 700. In some implementations, the computer system 700 can be an embedded computer system, a system-on-chip (SOC), a single-board computer system (SBC), or a distributed system such as a mesh of computer systems, or it can include one or more cloud components in one or more networks. Where appropriate, one or more computer systems 700 can perform operations in real time, in near real time, or in batch mode.

The network interface device 712 enables the computing system 700 to mediate data in a network 714 with an entity that is external to the computing system 700 through any communication protocol supported by the computing system 700 and the external entity. Examples of the network interface device 712 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 706, non-volatile memory 710, machine-readable medium 726) can be local, remote, or distributed. Although shown as a single medium, the machine-readable medium 726 can include multiple media (e.g., a centralized/distributed database and/or associated caches and servers) that store one or more sets of instructions 728. The machine-readable medium 726 can include any medium that is capable of storing, encoding, or carrying a set of instructions for execution by the computing system 700. The machine-readable medium 726 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 710, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 704, 708, 728) set at various times in various memory and storage devices in computing device(s). When read and executed by the processor 702, the instruction(s) cause the computing system 700 to perform operations to execute elements involving the various aspects of the disclosure.

### Further Examples

In some embodiments, the techniques described herein relate to a computer-implemented method, the method including receiving, via an application programming interface (API), real-time operation logs for at least one allocable resource unit corresponding to a target unit value, each operation log including (1) a set of operational attributes for distribution of the at least one allocable resource unit, and (2) a set of profiling attributes for a receiving end user of the at least one allocable resource unit. In some embodiments, the method includes determining, using the set of operational attributes of the real-time operation logs, a set of key performance indicators (KPIs) for the at least one allocable resource unit. In some embodiments, the method includes responsive to at least one KPI failing to satisfy a stability threshold, generating, via a first machine learning model, a forecasting time-series dataset using the real-time operation logs for the at least one allocable resource unit, wherein the forecasting time-series dataset represents predicted operational attributes for the at least one allocable resource unit over a time interval. In some embodiments, the method includes generating, via a second machine learning model, a set of adjustment values for the predicted operational attributes of the forecasting time-series dataset using the set of profiling attributes for the receiving end user. In some embodiments, the method includes determining a modified target unit value for the at least one allocable resource unit based on the forecasting time-series dataset and the set of adjustment values. In some embodiments, the method includes displaying, at a user interface, a notification alert indicating deviation of the at least one KPI and recommendation for adjusting the target unit value, wherein the notification alert includes a user interactive element that, when selected, automatically updates the target unit value to the modified target unit value.

In some embodiments, the method includes causing a generative machine learning model to generate a human-readable narrative that identifies a subset of operational attributes for distribution of the at least one allocable resource unit that contributes to the recommendation for adjusting the target unit value to the modified target unit value. In some embodiments, the method includes and displaying, at the user interface, the human-readable narrative within the user interactive element for adjusting the target unit value to the modified target unit value.

In some embodiments, the method includes grouping the real-time operation logs into a set of end user categories based on the profiling attributes of the receiving end user of the at least one resource unit, wherein each end user category represents one or more receiving end users that share similar profiling attributes. In some embodiments, the method includes generating, via the second machine learning model, a unique set of adjustment values for each end user category using the profiling attributes of member receiving end users. In some embodiments, the method includes determining a unique modified target unit value for each end user category based on the forecasting time-series dataset and the unique set of adjustment values for the end user category.

In some embodiments, the set of adjustment values is a first set of adjustment values, and the method further includes accessing a manifest including logistical information for available supply of the at least one resource unit. In some embodiments, the method includes generating, via a third machine learning model, a second set of adjustment values for the predicted operational attributes of the forecasting time-series dataset using the logistical information of the manifest. In some embodiments, the method includes updating the modified target unit value based on the forecasting time-series dataset, the first set of adjustment values, and the second set of adjustment values.

In some embodiments, the method includes receiving, from the user interface, a user selection for a subset of available operational attributes for the real-time operation logs. In some embodiments, the method includes generating, via the first machine learning model, a second forecasting time-series dataset using the selected subset of available operational attributes for the real-time operation logs. In some embodiments, the method includes updating the modified target unit value based on the second forecasting time-series dataset and the set of adjustment values.

In some embodiments, the method includes displaying, at the user interface, the operational attributes and the KPIs of the real-time operation logs for the at least one allocable resource unit in a tabular format, wherein the KPIs for the operation logs are row aligned and the operational attributes of the operation logs are column aligned, and wherein each intersection of the tabular format comprises a cell element presenting a selected KPI for a corresponding operational attribute.

In some embodiments, the method includes responsive to a user selection of at least one cell element from the displayed tabular format, displaying, at the user interface, an enumerated list of operation logs comprising the operational attribute of the selected at least one cell element.

In some embodiments, the cell element of the tabular format corresponding to the at least one KPI displays a distinguishing visual marker indicating failure to satisfy the stability threshold.

In some embodiments, the set of operational attributes for distribution of the at least one allocable resource unit includes a standard unit value, a target unit value, a realized unit value, a distributive resource value, an alternative resource unit value, a discounted unit value, a promotional unit value, a penalty value, a taxation value, a maintenance value, a surplus value, a quantity of resource distributions, a quantity of available resource units, a variable attribute of allocable resource units, a variable attribute of resource unit distributions, a logistics parameter of resource units, or a combination thereof.

In some embodiments, the set of KPIs includes a change in resource unit value, a comparative value of realized unit value to the target unit value, a range of resource unit values, a change in distributive unit value, a comparative value of realized unit value to the distributive unit value, a change in quantity of resource unit distributions, a change in quantity of available resource units, a change in variable attribute of resource units, a change in logistics parameter of resource units, or a combination thereof.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense-that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

We claim:

1. A computer-implemented method, the method comprising:
receiving, via an application programming interface (API), real-time operation logs for at least one allocable resource unit corresponding to a target unit value, each operation log comprising:
(1) a set of operational attributes for distribution of the at least one allocable resource unit, and
(2) a set of profiling attributes for a receiving end user of the at least one resource unit;
determining, using the set of operational attributes of the real-time operation logs, a set of key performance indicators (KPIs) for the at least one allocable resource unit;
responsive to at least one KPI failing to satisfy a stability threshold, generating, via a first machine learning model, a forecasting time-series dataset using the real-time operation logs for the at least one allocable resource unit,
wherein the forecasting time-series dataset represents predicted operational attributes for the at least one allocable resource unit over a time interval;
generating, via a second machine learning model, a set of adjustment values for the predicted operational attributes of the forecasting time-series dataset using the set of profiling attributes for the receiving end user;
determining a modified target unit value for the at least one allocable resource unit based on the forecasting time-series dataset and the set of adjustment values; and
configuring for display, at a user interface, a notification alert indicating deviation of the at least one KPI and a recommendation for adjusting the target unit value,
wherein the notification alert comprises a user interactive element that, when selected, automatically updates the target unit value to the modified target unit value.

2. The computer-implemented method of claim 1 further comprising:
causing a generative machine learning model to generate a human-readable narrative that identifies a subset of operational attributes for distribution of the at least one allocable resource unit that contributes to the recommendation for adjusting the target unit value to the modified target unit value; and
configuring for display, at the user interface, the human-readable narrative within the user interactive element for adjusting the target unit value to the modified target unit value.

3. The computer-implemented method of claim 1 further comprising:
grouping the real-time operation logs into a set of end user categories based on the profiling attributes of the receiving end user of the at least one resource unit,
wherein each end user category represents one or more receiving end users that share similar profiling attributes;
generating, via the second machine learning model, a unique set of adjustment values for each end user category using the profiling attributes of member receiving end users; and
determining a unique modified target unit value for each end user category based on the forecasting time-series dataset and the unique set of adjustment values for the end user category.

4. The computer-implemented method of claim 1, wherein the set of adjustment values is a first set of adjustment values, and wherein the method further comprises:
accessing a manifest comprising logistical information for available supply of the at least one resource unit;
generating, via a third machine learning model, a second set of adjustment values for the predicted operational attributes of the forecasting time-series dataset using the logistical information of the manifest; and
updating the modified target unit value based on the forecasting time-series dataset, the first set of adjustment values, and the second set of adjustment values.

5. The computer-implemented method of claim 1 further comprising:
receiving, from the user interface, a user selection for a subset of available operational attributes for the real-time operation logs;
generating, via the first machine learning model, a second forecasting time-series dataset using the selected subset of available operational attributes for the real-time operation logs; and
updating the modified target unit value based on the second forecasting time-series dataset and the set of adjustment values.

6. The computer-implemented method of claim 1 further comprising:
displaying, at the user interface, the operational attributes and the KPIs of the real-time operation logs for the at least one allocable resource unit in a tabular format,
wherein the KPIs for the operation logs are row aligned and the operational attributes of the operation logs are column aligned, and
wherein each intersection of the tabular format comprises a cell element presenting a selected KPI for a corresponding operational attribute.

7. The computer-implemented method of claim 6 further comprising:
responsive to a user selection of at least one cell element from the displayed tabular format, displaying, at the user interface, an enumerated list of operation logs comprising the operational attribute of the selected at least one cell element.

8. The computer-implemented method of claim 6, wherein the cell element of the tabular format corresponding to the at least one KPI displays a distinguishing visual marker indicating failure to satisfy the stability threshold.

9. The computer-implemented method of claim 1, wherein the set of operational attributes for distribution of the at least one allocable resource unit comprises a standard unit value, a target unit value, a realized unit value, a distributive resource value, an alternative resource unit value, a discounted unit value, a promotional unit value, a penalty value, a taxation value, a maintenance value, a surplus value, a quantity of resource distributions, a quantity of available resource units, a variable attribute of allocable resource units, a variable attribute of resource unit distributions, a logistics parameter of resource units, or a combination thereof.

10. The computer-implemented method of claim 1, wherein the set of KPIs comprises a change in resource unit value, a comparative value of realized unit value to the target unit value, a range of resource unit values, a change in distributive unit value, a comparative value of realized unit value to the distributive unit value, a change in quantity of resource unit distributions, a change in quantity of available resource units, a change in variable attribute of resource units, a change in logistics parameter of resource units, or a combination thereof.

11. A non-transitory, computer-readable storage medium comprising instructions recorded thereon, wherein the instructions when executed by at least one data processor of a system, cause the system to:
receive, via an application programming interface (API), real-time operation logs for at least one allocable resource unit corresponding to a target unit value, each operation log comprising:
(1) a set of operational attributes for distribution of the at least one allocable resource unit, and
(2) a set of profiling attributes for a receiving end user of the at least one resource unit;
determine, using the set of operational attributes of the real-time operation logs, a set of key performance indicators (KPIs) for the at least one allocable resource unit;
responsive to at least one KPI failing to satisfy a stability threshold, generate, via a first machine learning model, a forecasting time-series dataset using the real-time operation logs for the at least one allocable resource unit,
wherein the forecasting time-series dataset represents predicted operational attributes for the at least one allocable resource unit over a time interval;
generate, via a second machine learning model, a set of adjustment values for the predicted operational attributes of the forecasting time-series dataset using the set of profiling attributes for the receiving end user;
determine a modified target unit value for the at least one allocable resource unit based on the forecasting time-series dataset and the set of adjustment values; and
display, at a user interface, a notification alert indicating deviation of the at least one KPI and recommendation for adjusting the target unit value,
wherein the notification alert comprises a user interactive element that, when selected, automatically updates the target unit value to the modified target unit value.

12. The non-transitory, computer-readable storage medium of claim 11, wherein the instructions further cause the system to:
group the real-time operation logs into a set of end user categories based on the profiling attributes of the receiving end user of the at least one resource unit,
wherein each end user category represents one or more receiving end users that share similar profiling attributes;
generate, via the second machine learning model, a unique set of adjustment values for each end user category using the profiling attributes of member receiving end users; and
determine a unique modified target unit value for each end user category based on the forecasting time-series dataset and the unique set of adjustment values for the end user category.

13. The non-transitory, computer-readable storage medium of claim 11, wherein the set of adjustment values is a first set of adjustment values, and wherein the instructions further cause the system to:
access a manifest comprising logistical information for available supply of the at least one resource unit;
generate, via a third machine learning model, a second set of adjustment values for the predicted operational attributes of the forecasting time-series dataset using the logistical information of the manifest; and
update the modified target unit value based on the forecasting time-series dataset, the first set of adjustment values, and the second set of adjustment values.

14. The non-transitory, computer-readable storage medium of claim 11, wherein the instructions further cause the system to:
display, at the user interface, the operational attributes and the KPIs of the real-time operation logs for the at least one allocable resource unit in a tabular format,
wherein the KPIs for the operation logs are row aligned and the operational attributes of the operation logs are column aligned, and
wherein each intersection of the tabular format comprises a cell element presenting a selected KPI for a corresponding operational attribute.

15. The non-transitory, computer-readable storage medium of claim 14, wherein the instructions further cause the system to:
responsive to a user selection of at least one cell element from the displayed tabular format, display, at the user interface, an enumerated list of operation logs comprising the operational attribute of the selected at least one cell element.

16. A system comprising:
at least one hardware processor; and
at least one non-transitory memory storing instructions, which, when executed by the at least one hardware processor, cause the system to:
receive, via an application programming interface (API), real-time operation logs for at least one allocable resource unit corresponding to a target unit value, each operation log comprising:
(1) a set of operational attributes for distribution of the at least one allocable resource unit, and
(2) a set of profiling attributes for a receiving end user of the at least one resource unit;
determine, using the set of operational attributes of the real-time operation logs, a set of key performance indicators (KPIs) for the at least one allocable resource unit;
responsive to at least one KPI failing to satisfy a stability threshold, generate, via a first machine learning model, a forecasting time-series dataset using the real-time operation logs for the at least one allocable resource unit,
wherein the forecasting time-series dataset represents predicted operational attributes for the at least one allocable resource unit over a time interval;
generate, via a second machine learning model, a set of adjustment values for the predicted operational attributes of the forecasting time-series dataset using the set of profiling attributes for the receiving end user;
determine a modified target unit value for the at least one allocable resource unit based on the forecasting time-series dataset and the set of adjustment values; and
display, at a user interface, a notification alert indicating deviation of the at least one KPI and recommendation for adjusting the target unit value,
wherein the notification alert comprises a user interactive element that, when selected, automatically updates the target unit value to the modified target unit value.

17. The system of claim 16 further caused to:
cause a generative machine learning model to generate a human-readable narrative that identifies a subset of operational attributes for distribution of the at least one allocable resource unit that contributes to the recommendation for adjusting the target unit value to the modified target unit value; and
display, at the user interface, the human-readable narrative within the user interactive element for adjusting the target unit value to the modified target unit value.

18. The system of claim 16 further caused to:
receive, from the user interface, a user selection for a subset of available operational attributes for the real-time operation logs;
generate, via the first machine learning model, a second forecasting time-series dataset using the selected subset of available operational attributes for the real-time operation logs; and
update the modified target unit value based on the second forecasting time-series dataset and the set of adjustment values.

19. The system of claim 16 further caused to:
display, at the user interface, the operational attributes and the KPIs of the real-time operation logs for the at least one allocable resource unit in a tabular format,
wherein the KPIs for the operation logs are row aligned and the operational attributes of the operation logs are column aligned, and
wherein each intersection of the tabular format comprises a cell element presenting a selected KPI for a corresponding operational attribute.

20. The system of claim 19 further caused to:
responsive to a user selection of at least one cell element from the displayed tabular format, display, at the user interface, an enumerated list of operation logs comprising the operational attribute of the selected at least one cell element.
